(19) United States
(12) Patent Application Publication
(10) Pub. No.: US 2024/0221399 A1
(43) Pub. Date: Jul. 4, 2024

(54) VEHICLE DETECTION DEVICE, VEHICLE DETECTION METHOD, AND NON TRANSITORY COMPUTER-READABLE MEDIUM

(71) Applicant: DENSO CORPORATION, Kariya-city (JP)

(72) Inventors: SUGURU YAMAZAKI, Kariya-city (JP); TOMOYUKI OISHI, Kariya-city (JP)

(21) Appl. No.: 18/608,639

(22) Filed: Mar. 18, 2024

Related U.S. Application Data
(63) Continuation of application No. PCT/JP2022/032259, filed on Aug. 26, 2022.

(30) Foreign Application Priority Data
Sep. 21, 2021 (JP) 2021-153459

(51) Int. Cl. G06V 20/64; G01J 1/42; G01S 7/481; G01S 17/89; G01S 17/931; G06V 10/776; G06V 20/58

(52) U.S. Cl. CPC G06V 20/64; G01J 1/4204; G01S 7/4816; G01S 17/89; G01S 17/931; G06V 10/776; G06V 20/58; G06V 2201/08

(57) ABSTRACT

An image obtainer detects a reflected light to obtain a reflected light image representing an intensity distribution of the reflected light, and detects an ambient light not including the reflected light to obtain a background light image representing an intensity distribution of the ambient light. A distinction detector distinguishes and detects, from the background light image, a vehicle area and a parts area in which an intensity of the reflected light tends to be high. An intensity identifier identifies a magnitude of a light intensity of the background light image and the reflected light image. A validity determiner determines validity of arrangement of the parts area based on the intensity distribution of the reflected light image in the parts area. A vehicle detector detects the vehicle by using the magnitude of the light intensity of the background light image and the reflected light image and the validity.

### CROSS REFERENCE TO RELATED APPLICATION

The present application is a continuation application of International Patent Application No. PCT/JP2022/032259 filed on Aug. 26, 2022, which designated the U.S. and claims the benefit of priority from Japanese Patent Application No. 2021-153459 filed in Japan on Sep. 21, 2021. The entire disclosures of all of the above applications are incorporated herein by reference.

### TECHNICAL FIELD

The present disclosure relates to a vehicle detection device, a vehicle detection method, and a non-transitory computer-readable medium storing a vehicle detection program.

### BACKGROUND

Conventionally, a detection device, which is configured to irradiate light to an object such as a vehicle and detect the object based on an intensity of light reflected on the object, has been known.

### SUMMARY

According to an aspect of the present disclosure, a vehicle detection device detects a reflected light of a light irradiated to a detection area, obtains a reflected light image representing an intensity distribution of the reflected light, and detects a vehicle by using the reflected light image.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram of an example of a schematic configuration of a vehicle system;

FIG. 2 is a diagram of an example of a schematic configuration of an image processing device;

FIG. 3 is a diagram of an example of a vehicle area and a parts area in a background light image;

FIG. 4 is a diagram for explaining a relationship between (a) a light intensity of each of a reflected light image and a background light image regarding a vehicle area and (b) detection of an estimated state of the vehicle area;

FIG. 5 is a flowchart of an example of a flow of vehicle detection related process in a processing unit;

FIG. 6 is a diagram of an example of a schematic configuration of the vehicle system; and

FIG. 7 is a diagram of an example of a schematic configuration of the image processing device.

### DETAILED DESCRIPTION

Hereinafter, examples of the present disclosure will be described.

According to an example of the present disclosure, a technique is employable for detecting an object such as a vehicle. Specifically, the technique uses, as a pixel value of each pixel, a received intensity of a reflected light of an irradiation light in a reflection intensity image. The technique may obtain, as a distance measurement point, a pixel whose reflection intensity is equal to or higher than a predetermined intensity.

However, in a case where a vehicle is a detection target, the intensity of the reflected light decreases due to factors such as a dirt on the vehicle surface, a color of the vehicle and the like. Due to such factors, only a small number of distance measurement points are obtainable. Consequently, a vehicle may be hardly detectable with the technique.

According to an example of the present disclosure, a vehicle detection device comprises:
an image obtainer configured to detect, with a light receiving element, a reflected light of a light irradiated to a detection area to obtain a reflected light image representing an intensity distribution of the reflected light, and detect, with the light receiving element, an ambient light, which does not include the reflected light, in the detection area to obtain a background light image representing an intensity distribution of an ambient light;
a distinction detector configured to distinguish and detect, from the background light image obtained by the image obtainer, a vehicle area, which is estimated as likely to be a vehicle, and a parts area, which is estimated as likely to be a specific vehicle part in which an intensity of the reflected light tends to be high;
an intensity identifier configured to identify a magnitude of a light intensity of each of the background light image and the reflected light image, which is obtained by the image obtainer, in the vehicle area detected by the distinction detector;
a validity determiner configured to determine validity of arrangement of the parts area based on the intensity distribution of the reflected light image, which is obtained by the image obtainer, in the parts area, which is detected by the distinction detector; and
a vehicle detector configured to detect the vehicle by using the magnitude of the light intensity of each of the background light image and the reflected light image, which is identified by the intensity identifier and the validity of the arrangement of the parts area, which is determined by the validity determiner.

According to an example of the present disclosure, a vehicle detection method is implemented by at least one processor. The vehicle detection method comprises:
detecting, in an image obtainer process, with a light receiving element, a reflected light of a light irradiated to a detection area to obtain a reflected light image representing an intensity distribution of the reflected light;
detecting, in the image obtainer process, with the light receiving element, an ambient light, which does not include the reflected light, in the detection area to obtain a background light image representing an intensity distribution of an ambient light;
distinguishing and detecting, in a distinction detector process, from the background light image obtained in the image obtainer process, a vehicle area, which is estimated as likely to be a vehicle, and a parts area, which is estimated as likely to be a specific vehicle part in which an intensity of the reflected light tends to be high;
identifying, in an intensity identifier process, magnitude of a light intensity of each of the background light image and the reflected light image, which is obtained in the image obtainer process, in the vehicle area, which is detected in the distinction detector process;
determining, in a validity determiner process, validity of arrangement of the parts area based on the intensity distribution of the reflected light image, which is obtained in the image obtainer process, in the parts area, which is detected in the distinction detector process; and
detecting, in a vehicle detector process, the vehicle by using the magnitude of the light intensity of each of the background light image and the reflected light image, which is identified in the intensity identifier process, and the validity of the arrangement of the parts area, which is determined in the validity determiner process.

According to an example of the present disclosure, a non-transitory computer readable medium stores a computer program comprising instructions configured to be executed by at least one processor. The instructions are configured to, when executed by the at least one processor, cause the at least one processor to:
detect, in an image obtainer process, with a light receiving element, a reflected light of a light irradiated to a detection area to obtain a reflected light image representing an intensity distribution of the reflected light;
detect, in the image obtainer process, with the light receiving element, an ambient light, which does not include the reflected light, in the detection area to obtain a background light image representing an intensity distribution of an ambient light;
distinguish and detect, in a distinction detector process, from the background light image obtained in the image obtainer process, a vehicle area, which is estimated as likely to be a vehicle, and a parts area, which is estimated as likely to be a specific vehicle part in which an intensity of the reflected light tends to be high;
identify, in an intensity identifier process, magnitude of a light intensity of each of the background light image and the reflected light image, which is obtained in the image obtainer process, in the vehicle area, which is detected in the distinction detector process;
determine, in a validity determiner process, validity of arrangement of the parts area based on the intensity distribution of the reflected light image, which is obtained in the image obtainer process, in the parts area, which is detected in the distinction detector process; and
detect, in a vehicle detector process, the vehicle by using the magnitude of the light intensity of each of the background light image and the reflected light image, which is identified in the intensity identifier process, and the validity of the arrangement of the parts area, which is determined in the validity determiner process.

According to the above, a vehicle is detected using magnitude, i.e., high and low levels, of the light intensity of the background light image and the reflected light image for the detection area, and the validity of the parts area. Depending on whether or not a vehicle is located in the detection area, possible patterns of trends in the light intensity of the background light image and the reflected light image are narrowed down. Therefore, by detecting a vehicle using the respective levels of light intensity of the background light image and the reflected light image regarding the detection area, it becomes possible to detect the vehicle with higher accuracy. In addition, because the parts area is an area that is assumed to be a specific part of the vehicle where the intensity of the reflected light tends to be high, even if a vehicle body has a low reflectance, it is estimated that the intensity of the reflected light therefrom is high. Therefore, it is highly possible that an intensity distribution in the reflected light image will also vary according to the arrangement of that specific vehicle part.

Therefore, by using the validity of the arrangement of the parts area derived from the intensity distribution in the reflected light image, it becomes possible to detect the vehicle with higher accuracy. As a result, even when an image representing the received intensity of the reflected light is used to detect a vehicle, it is possible to detect the vehicle with high accuracy.

Multiple embodiments will be described for disclosure hereinafter with reference to the drawings. For convenience of description, parts having the same functions as those of the parts shown in the drawings used for the previous description in the plurality of embodiments may be denoted by the same reference signs and the description thereof may be omitted. Description in another applicable embodiment may be referred to for such a portion denoted by the identical reference sign.

### Embodiment 1

### Schematic Configuration of Vehicle System 1

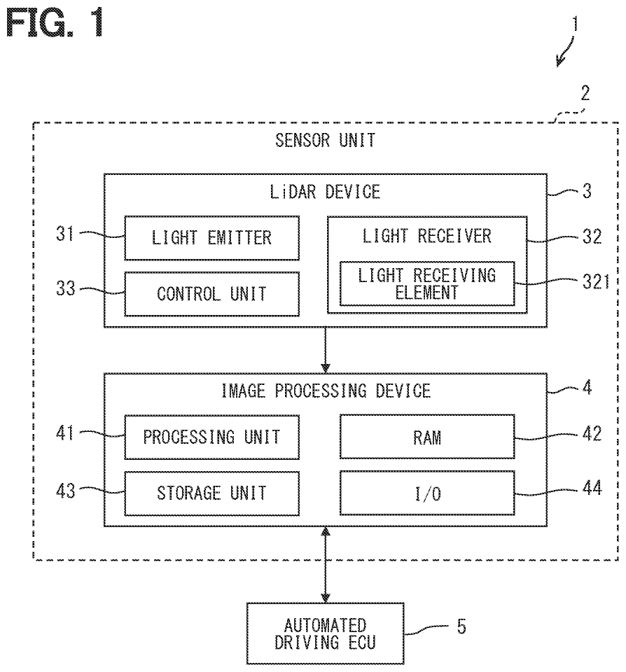

A vehicle system 1 can be used in a vehicle. The vehicle system 1 includes a sensor unit 2 and an automatic driving ECU 5, as shown in FIG. 1. Although the vehicle using the vehicle system 1 is not necessarily limited to an automobile, hereinafter, an example using the automobile will be described. A vehicle using the vehicle system 1 is hereinafter referred to as an own vehicle.

The automatic driving ECU 5 recognizes a travel environment around the own vehicle based on information output from the sensor unit 2. The automatic driving ECU 5 generates a travel plan for automatically driving the own vehicle using an automatic driving function based on the recognized travel environment. The automatic driving ECU 5 realizes automatic driving in cooperation with an ECU that performs travel control. The automatic driving mentioned here may be automatic driving in which the system performs both acceleration/deceleration control and steering control on behalf of a driver, or automatic driving in which the system performs some of these controls on behalf of the driver.

The sensor unit 2 includes a LiDAR device 3 and an image processing device 4, as shown in FIG. 1. The sensor unit can also be referred to as a sensor package. The LiDAR device 3 is an optical sensor that irradiates light to a predetermined range around the own vehicle, and detects reflected light that is reflected by a target object. This predetermined range can be set arbitrarily. Hereinafter, the range to be measured by the LiDAR device 3 will be referred to as a detection area. The LiDAR device 3 maybe implemented as a SPAD (Single Photon Avalanche Diode) LiDAR. A schematic configuration of the LiDAR device 3 will be described later.

The image processing device 4 is connected to the LiDAR device 3. The image processing device 4 obtains image data such as a reflected light image and a background light image, which will be described later, output from the LiDAR device 3, and detects a target object from these image data. In the following, a configuration for detecting a vehicle using the image processing device 4 will be explained. A schematic configuration of the image processing device 4 will be described later.

### Schematic Configuration of LiDAR Device 3

Here, the schematic configuration of the LiDAR device 3 will be described using FIG. 1. As shown in FIG. 1, the LiDAR device 3 includes a light emitter 31, a light receiver 32, and a control unit 33.

The light emitter 31 irradiates a detection area with a light beam emitted from a light source by scanning the light beam using a movable optical member. An example of the movable optical member is a polygon mirror. For example, a semiconductor laser may be used as the light source. The light emitter 31 emits, for example, a light beam in a non-visible region in a pulsed manner in response to an electric signal from the control unit 33. The non-visible region is a wavelength range that is invisible to humans. As an example, the light emitter 31 mayemit a light beam in the near-infrared region as the light beam in the non-visible region.

The light receiver 32 has a light receiving element 321. Note that the light receiver 32 mayalso have a condensing lens. The condensing lens condenses the reflected light of the light beam reflected by the target object in the detection area and the background light relative to the reflected light, and makes the condensed light enter the light receiving element 321. The light receiving element 321 is an element that converts light into an electrical signal by photoelectric conversion. The light receiving element 321 is assumed to have sensitivity in the non-visible region. As the light receiving element 321, in order to efficiently detect the reflected light of the light beam, a CMOS sensor that is set to have higher sensitivity in the near-infrared region than in the visible region may be used. The sensitivity of the light receiving element 321 to each wavelength range may be adjusted by an optical filter. The light receiving element 321 may be configured to have a plurality of light receiving pixels arranged in an array in one or two dimensions. Each light-receiving pixel may have a configuration using SPAD. This light-receiving pixel may be capable of highly sensitive light detection by amplifying electrons generated by photon incidence by avalanche multiplication.

The control unit 33 controls the light emitter 31 and the light receiver 32. The control unit 33 maybe arranged on a common substrate with the light receiving element 321, for example. The control unit 33 is mainly composed of a broadly-defined processor such as a microcontroller (hereinafter referred to as a microcomputer) or an

FPGA (Field-Programmable Gate Array). The control unit 33 implements a scan control function, a reflected light measurement function, and a background light measurement function.

The scan control function is a function that controls scanning of the light beam by the light emitter 31. The control unit 33 causes the light source to oscillate a light beam multiple times in a pulsed manner at a timing based on an operating clock of a clock oscillator provided in the LiDAR device 3. In addition, the control unit 33 operates the movable optical member in synchronization with the irradiation of the light beam.

The reflected light measurement function is a function of reading out, according to the scan timing of the light beam, a voltage value corresponding to the reflected light received by each light receiving pixel, and measuring an intensity of the reflected light. The control unit 33 senses an arrival time of the reflected light based on the timing of a peak occurrence in an output pulse of the light receiving element 321. The control unit 33 measures a time of flight of the light by measuring a time difference between an emission time of the light beam from the light source and the arrival time of the reflected light.

Through the cooperation of the above scan control function and reflected light measurement function, a reflected light image, which is image-like data, is generated. The control unit 33 maymeasure the reflected light using a rolling shutter method and generate a reflected light image. The details of the above are described as follows. The control unit 33 generates information about pixel groups arranged in the horizontal direction on an image plane corresponding to the detection area, one line or a plurality of lines at a time, for example, in accordance with the scanning of the light beam in the horizontal direction. The control unit 33 vertically combines pixel information sequentially generated for each row to generate one reflected light image.

The reflected light image is image data including distance information obtained when the light receiving element 321 detects reflected light corresponding to light irradiation from the light emitter 31. Each pixel of the reflected light image includes a value indicating the time of flight of the light. The value indicating the time of flight of the light can also be rephrased as a distance value indicating a distance from the LiDAR device 3 to a reflection point of an object located in the detection area. Further, each pixel of the reflected light image includes a value indicating an intensity of the reflected light. An intensity distribution of the reflected light may be converted into data as a brightness distribution by gradation. In other words, the reflected light image becomes image data representing the brightness distribution of the reflected light. The reflected light image can also be referred to as an image in which the intensity of the reflected light from a target object is converted into pixel values.

The background light measurement function is a function that reads a voltage value based on an ambient light received by each light receiving pixel at a timing immediately before measuring reflected light, and measures the intensity of the ambient light. The term “ambient light” as used herein means an incident light that is incident on the light receiving element 321 from the detection area and does not substantially include the reflected light. The incident light includes a natural light, a display light incident from external displays, and the like. In the following, the ambient light will be referred to as a background light. The background light image can also be referred to as an image in which the brightness of a surface of the target object is converted into pixel values.

Similar to the reflected light image, the control unit 33 measures a background light using a rolling shutter method, and generates a background light image. The intensity distribution of the background light may be converted into data as a brightness distribution by gradation. The background light image is image data representing the brightness distribution of the background light before light irradiation, and includes brightness information of the background light detected by the same light receiving element 321 as the one detecting the reflected light. That is, the value of each pixel arranged two-dimensionally in the background light image is a brightness value indicating the intensity of the background light at the corresponding location in the detection area.

The reflected light image and the background light image are sensed by a common light receiving element 321 and obtained from a common optical system including the light receiving element 321. Therefore, the coordinate system of the reflected light image and the coordinate system of the background light image can be considered to be the same coordinate system that coincides with each other. In addition, it is assumed that there is almost no difference in measurement timing between the reflected light image and the background light image. For example, the measurement timing deviation is assumed to be less than 1 ns. Therefore, a set of continuously-obtained reflected light images and background light images can be considered to be time-synchronized. Further, in the reflected light image and the background light image, it is possible to unambiguously determine the correspondence between individual pixels. The control unit 33 treats the reflected light image and the background light image as integrated image data including 3-channel data of the intensity of the reflected light, the distance to the object, and the background light intensity, corresponding to each pixel, and sequentially outputs the image data to the image processing device 4.

### Schematic Configuration of Image Processing Device 4

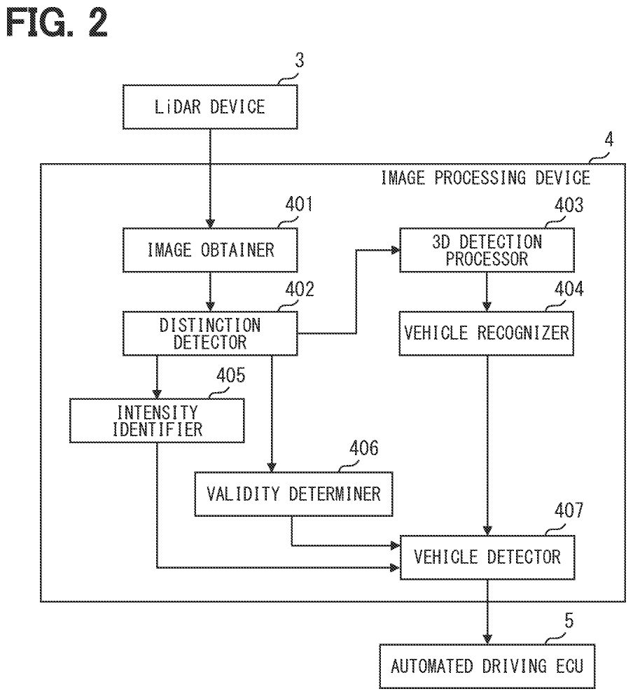

Next, the schematic configuration of the image processing device 4 will be explained using FIGS. 1 and 2. As shown in FIG. 1, the image processing device 4 is an electronic control device that includes an arithmetic circuit including a processing unit 41, a RAM 42, a storage unit 43, and an input/output interface (hereinafter referred to as I/O) 44 as main components. The processing unit 41, the RAM 42, the storage unit 43, and the I/O 44 maybe configured to be connected via a bus.

The processing unit 41 is hardware for arithmetic processing coupled with the RAM 42. The processing unit 41 includes at least one calculation core such as a CPU (Central Processing Unit), a GPU (Graphical Processing Unit), an FPGA or the like. The processing unit 41 can be configured as an image processing chip further including an IP core with other dedicated functions. The image processing chip may be an ASIC (Application Specific Integrated Circuit) designed for the automatic driving. The processing unit 41 accesses the RAM 42 to execute various processes for realizing the functions of each of the functional blocks, which will be described later.

The storage unit 43 includes a non-volatile storage medium. The storage medium is a non-transitory, tangible storage medium that non-temporarily stores computer-readable programs and data. The non-transitory, tangible storage medium is implemented by a semiconductor memory, a magnetic disk, or the like. The storage unit 43 stores various programs such as a vehicle detection program executed by the processing unit 41.

As shown in FIG. 2, the image processing device 4 includes an image obtainer 401, a distinction detector 402, a 3D detection processor 403, a vehicle recognizer 404, an intensity identifier 405, a validity determiner 406, and a vehicle detector 407 respectively as a functional block. The image processing device 4 corresponds to a vehicle detection device. Moreover, the execution of the processing of each functional block of the image processing device 4 by the computer corresponds to performing the vehicle detection method. Note that some or all of the functions executed by the image processing device 4 maybe configured in hardware using one or more ICs or the like. Further, some or all of the functional blocks included in the image processing device 4 maybe realized by a combination of software execution by a processor and hardware components.

The image obtainer 401 sequentially obtains reflected light images and background light images output from the LiDAR device 3. In other words, the image obtainer 401 obtains (a) a reflected light image representing the intensity distribution of the reflected light obtained by detecting the reflected light of the light irradiated to the detection area with the light receiving element 321, and (b) a background light image representing the intensity distribution of the ambient light obtained by detecting the ambient light of the detection area that does not include the reflected light with the light receiving element 321. This processing in the image obtainer 401 corresponds to an image obtainer process.

In the present embodiment, the image obtainer 401, more specifically, obtains (a) a reflected light image representing the intensity distribution of the reflected light obtained by detecting the reflected light of the light irradiated to the detection area with the light receiving element 321 having sensitivity in the non-visible region, and (b) a background light image representing the intensity distribution of the ambient light obtained by detecting the ambient light in the detection area that does not include reflected light using the light receiving element 321 at a timing different from the detection of the reflected light. The different timing mentioned here is a timing that (i) does not completely match the timing at which reflected light is measured, but (ii) is slightly shifted to an extent that it can be considered that the reflected light image and the background light image are synchronized. For example, such timing may be set to a timing immediately before measuring the reflected light and with a difference of less than 1 ns from the timing at which the reflected light is measured. That is, the image obtainer 401 obtains the reflected light image and the background light image mentioned above, which are synchronized in time, by linking them to each other.

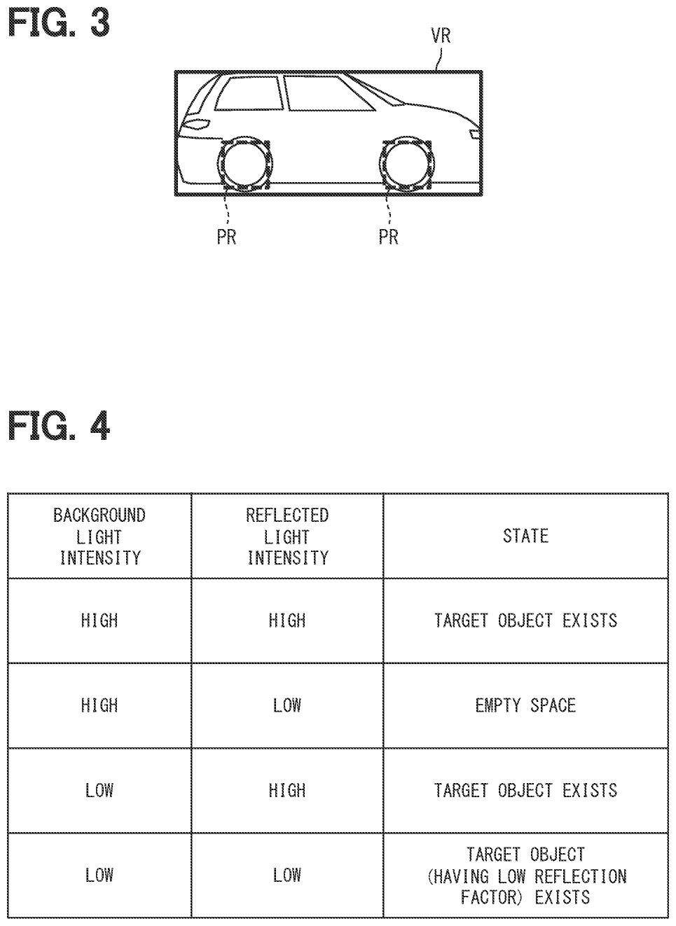

The distinction detector 402 distinguishes and detects a vehicle area and a parts area from the background light image obtained by the image obtainer 401. This processing by the distinction detector 402 corresponds to a distinction detector process. The parts area is an area that is estimated to be a specific vehicle part (hereinafter referred to as a specific vehicle part) where the intensity of the reflected light tends to be high. This specific vehicle part may be a tire wheel, a reflector, a license plate, or the like. In the following, a case where the specific vehicle part is a tire wheel will be described as an example. The vehicle area is an area that is estimated to be a vehicle. The vehicle area may be the area of an entire vehicle. An example is shown in FIG. 3. In FIG. 3, VR is a vehicle area, and PR is a parts area. The vehicle area may include a parts area as well. The vehicle area and the parts area detected by the distinction detector 402 are areas that are estimated to be a vehicle and a specific vehicle part, respectively, and may possibly be not a vehicle or a specific vehicle part.

The distinction detector 402 may distinguish and detect the vehicle area and the parts area using an image recognition technology. For example, the above-mentioned detection may be performed using a learning device that performs machine learning using an image of the entire vehicle as training information for the vehicle area and an image of a specific vehicle part as training information for the parts area. Note that the distinction detector 402 also distinguishes and detects the vehicle area and the parts area from the reflected light image that is time-synchronized with the background light image. The distinction detector 402, utilizing the fact that the background light image and the reflected light image are associated pixel by pixel with each other, may detect the vehicle area and the parts area from the reflected light image based on positions of the vehicle area and the parts area in the background light image.

In addition, the distinction detector 402, using a learning device that performs machine learning to determine the reflected light image by using an image of the entire vehicle as training information for the vehicle area and an image of a specific vehicle part as training information for the parts area, may distinguish and detect the vehicle area and the parts area. In such case, if detection results are obtained for both the background light image and the reflected light image, the detection result with the higher detection score may be adopted. Alternatively, the above-described processing may be performed on an image obtained by removing a disturbance light intensity from the reflected light image using the background light image.

The 3D detection processor 403 detects a three-dimensional target from a three-dimensional point group. The 3D detection processor 403 detects a three-dimensional target object by 3D detection process such as F-PointNet, PointPillars and the like. In the present embodiment, the explanation will be given assuming that F-PointNet is used as the 3D detection process. In F-PointNet, a two-dimensional object detection position in a two-dimensional image is projected three-dimensionally. Then, a three-dimensional point group included in a projected pillar (i.e., truncated pyramid) is input, and a three-dimensional target object is detected using deep learning. In the present embodiment, the vehicle area detected by the distinction detector 402 may be used as a two-dimensional object detection position. F-PointNet corresponds to a 3D detection process that indirectly uses at least one of the background light image and the reflected light image. Note that when adopting an algorithm that performs a 3D detection process using only a distance measurement point group detected by the LiDAR device 3 such as PointPillars, the 3D detection process may be performed on the reflected light image obtained by the image obtainer 401. These Point Pillars and the like correspond to the 3D detection process that directly uses the reflected light image.

The vehicle recognizer 404 performs vehicle recognition based on the result of the 3D detection process performed by the 3D detection processor 403. The vehicle recognizer 404 may recognize a vehicle using a group of points in the reflected light image obtained by the image obtainer 401 where the intensity of the reflected light is equal to or higher than a threshold value. The threshold value mentioned here may be arbitrarily set. For example, the intensity of the background light image may be set as a threshold value for each pixel. For example, the vehicle recognizer 404 may recognize a target object as a vehicle if the dimensions such as height, width, and depth of the target object obtained through the 3D detection process are dimensions suitable for a vehicle. On the other hand, if the dimensions of the target object obtained through the 3D detection process are not suitable for a vehicle, the vehicle recognizer 404 does not need to recognize the target object as a vehicle. For example, the intensity of the reflected light decreases due to factors such as dirt and color on the vehicle surface (hereinafter referred to as low reflection factors), thereby decreasing the number of points in a point group and disabling the vehicle recognizer 404 to recognize it as a vehicle in some case. Note that when the 3D detection processor 403 detects a high object score suggesting that the target object is likely to be a vehicle, it may be determined, i.e., recognized, as a vehicle based on whether or not the object score is equal to or higher than a certain threshold value.

The intensity identifier 405 identifies the level of light intensity of the background light image and the reflected light image obtained by the image obtainer 401 for the vehicle area detected by the distinction detector 402. This process by the intensity identifier 405 corresponds to an intensity identifier process. For example, the intensity identifier 405 may identify that the light intensity is high when an average value of the light intensities of all pixels in the vehicle area is equal to or greater than a threshold value. Further, the intensity identifier 405 may identify that the light intensity is low when the average value of the light intensities of all pixels in the vehicle area is less than a threshold value. Alternatively, the intensity identifier 405 may identify whether the light intensity of each pixel in the vehicle area is high or low based on whether the light intensity of each pixel in the vehicle area is equal to or greater than a threshold value. The threshold value mentioned here can be arbitrarily set, and may be a value that distinguishes the presence or absence of objects other than objects with low reflectance and low brightness such as black objects. The threshold value for the background light image and the threshold value for the reflected light image may be different.

The validity determiner 406 determines the validity of the arrangement of the parts area detected by the distinction detector 402 from the intensity distribution in the reflected light image obtained by the image obtainer 401. This process by the validity determiner 406 corresponds to a validity determiner process. The validity determiner 406 may determine that the arrangement of the parts area has validity, when the intensity distribution in the reflected light image obtained by the image obtainer 401 for the parts area detected by the distinction detector 402 is similar to a predetermined intensity distribution (hereinafter referred to as a typical intensity distribution) of the reflected light from a specific vehicle part of the vehicle. The above-described situation means that, since the intensity of the reflected light tends to be high at a specific vehicle part, it is likely that an intensity distribution of the reflected light image shows or accords with the arrangement of the specific vehicle part if a reflected light image includes a vehicle. An intensity distribution obtained in advance through learning may thus be used as the typical intensity distribution. On the other hand, if the intensity distribution in the reflected light image obtained by the image obtainer 401 is not similar to the typical intensity distribution, it may be determined that the arrangement of the parts area does not have validity. The intensity distribution obtained by performing histogram analysis may also be used.

Further, the validity determiner 406 may determine that the arrangement of the parts areas has validity when the intensity distribution in the reflected light image obtained by the image obtainer 401 is consistent with at least one of a positional relationship of a specific vehicle part in the vehicle and a positional relationship between specific vehicle parts. (hereinafter referred to as a typical positional relationship). The above-described situation means that, since a specific vehicle part tends to have a high intensity of the reflected light, it highly likely causes the intensity distribution thereof to agree with the arrangement indicative of (a) the positional relationship between the vehicle (i.e., an entire vehicle) and the specific vehicle part, and/or (b) the positional relationship between specific (i.e., different) vehicle parts. As the typical positional relationship, a positional relationship obtained in advance through learning may be used. On the other hand, if the intensity distribution in the reflected light image obtained by the image obtainer 401 does not match the typical positional relationship, it may be determined that the arrangement of the parts area does not have validity.

The validity determiner 406 may preferably determine that the arrangement of the parts area has validity when the intensity distribution in the reflected light image obtained by the image obtainer 401 is similar to the typical intensity distribution and is consistent with the typical positional relationship. In such case, if the intensity distribution in the reflected light image obtained by the image obtainer 401 is not similar to the typical intensity distribution or is not consistent with the typical positional relationship, the validity determiner 406 may determine that the arrangement of the parts area does not have validity. According to the above, the validity of the arrangement of the parts areas is determinable with higher accuracy.

The vehicle detector 407 detects a vehicle in the detection area. The vehicle detector 407 uses the level of the light intensity of the background light image and the reflected light image identified by the intensity identifier 405 and the validity of the arrangement of the parts area determined by the validity determiner 406 to detect the vehicle. The above-described process in the vehicle detector 407 corresponds to a vehicle detector process. It is preferable that the vehicle detector 407 detects the vehicle when the vehicle recognizer 404 have recognized the vehicle. According to the above, if the vehicle has few low reflection factors, a sufficient number of points are obtained in a point group thereby enabling the vehicle recognizer 404 to recognize a vehicle, the vehicle is detectable from the recognition result of the vehicle recognizer 404.

It is preferable that the vehicle detector 407 detects a vehicle when the intensity identifier 405 identifies that the light intensity of the reflected light image for the vehicle area is high. The above-described situation means that, when the light intensity of the reflected light image for the vehicle area is high, there is a high possibility that a vehicle exists in such an image. Even if the vehicle recognizer 404 cannot recognize the vehicle, the vehicle detector 407 may preferably detect the vehicle if the intensity identifier 405 identifies that the light intensity of the reflected light image for the vehicle area is high. This means that, even if the vehicle recognizer 404 is unable to recognize a vehicle because a sufficient number of points cannot be obtained in a point group due to low reflection factors, if the light intensity of the reflected light image for the vehicle area is high, there is a high possibility that a vehicle exists in the image.

Preferably, the vehicle detector 407 does not detect a vehicle when the intensity identifier 405 identifies that only the light intensity of the reflected light image is low among the reflected light image and the background light image for the vehicle area. The above-described situation means that, if only the light intensity of the reflected light image is low among the reflected light image and the background light image for the vehicle area low, there is a high possibility that the vehicle area is an empty space. On the other hand, the vehicle detector 407 preferably detects a vehicle when the intensity identifier 405 identifies that the light intensity of both the reflected light image and the background light image for the vehicle area is low. This means that, if the light intensity of both the reflected light image and the background light image for the vehicle area is low, there is a high possibility that a vehicle with a low reflection factor exists in the vehicle area.

When (a) the vehicle recognizer 404 cannot recognize the vehicle, and (b) the intensity identifier 405 identifies that the light intensity of the reflected light image is low among the reflected light image and the background light image for the vehicle area, it is preferable for the vehicle detector 407 not to detect the vehicle. On the other hand, when (a) the vehicle recognizer 404 cannot recognize the vehicle, and (b) the intensity identifier 405 identifies that the light intensity of both the reflected light image and the background light image for the vehicle area is low, it is preferable for the vehicle detector 407 to detect the vehicle. This means that, even if the vehicle recognizer 404 is unable to recognize a vehicle because a sufficient number of points cannot be obtained in a point group due to low reflection factors, based on the low light intensity of both the reflected light image and the background light image for the vehicle area, it is possible to accurately detect a vehicle with low reflection factors.

Here, using FIG. 4, the relationship between the light intensity of the reflected light image and the background light image for the vehicle area identified by the intensity identifier 405 and the detection of the estimated state of the vehicle area will be described. In FIG. 4, the light intensity of the background light image is indicated as a background light intensity. In FIG. 4, the light intensity of the reflected light image is indicated as a reflected light intensity. As shown in FIG. 4, when both the background light intensity and the reflected light intensity are high, the state of the vehicle area is estimated to be that a target object exists. Therefore, the vehicle detector 407 detects a vehicle. If the background light intensity is high but the reflected light intensity is low, the state of the vehicle area is estimated to be an empty space. Therefore, the vehicle detector 407 does not detect a vehicle. When the background light intensity is low but the reflected light intensity is high, the state of the vehicle area is estimated to be that a target object exists. Therefore, the vehicle detector 407 does not detect a vehicle. If both the background light intensity and the reflected light intensity are low, it is estimated that the vehicle area contains a target object that has a low reflection factor. Therefore, the vehicle detector 407 does not detect a vehicle.

Furthermore, it is preferable that the vehicle detector 407 does not detect a vehicle when the validity determiner 406 determines that the arrangement of the parts area does not have validity. The above-described situation means that, if there is no validity in the arrangement of the parts area, there is a high possibility that it is not a vehicle. The vehicle detector 407 may have a configuration in which a vehicle is not detected when (a) the vehicle recognizer 404 cannot recognize a vehicle and (b) the validity determiner 406 determines that the arrangement of the parts area does not have validity.

Even if the validity determiner 406 determines that the arrangement of the parts area has validity, in case that the intensity identifier 405 identifies that only the light intensity of the reflected light image is low among the reflected light image and the background light image of the vehicle area, it is preferable for the vehicle detector 407 not to detect a vehicle. The above-described situation means that, even if the arrangement of the parts area has validity, if only the light intensity of the reflected light image among the reflected light image and the background light image for the vehicle area is low, there is a high possibility that it is not a vehicle. Therefore, according to the above configuration, it is possible to further improve the accuracy of vehicle detection. In case that (a) the vehicle recognizer 404 cannot recognize a vehicle, (b) the validity determiner 406 determines that the arrangement of the parts area has validity, and (c) the intensity identifier 405 identifies that only the light intensity of the reflected light image is low among the reflected light image and the background light image for the vehicle area, it is also preferable for the vehicle detector 407 not to detect a vehicle.

When (a) the validity determiner 406 determines that the arrangement of the parts area has validity, and (b) the intensity identifier 405 determines the light intensity of both the reflected light image and the background light image for the vehicle area is low, it is preferable for the vehicle detector 407 to detect a vehicle. The above-described situation means that, if (a) the arrangement of the parts area has validity and (b) the light intensity of both the reflected light image and the background light image for the vehicle area is low, the possibility is particularly high that a vehicle with a low reflection factor exists in the vehicle area. According to the above-described configuration, it is possible to further improve the accuracy of vehicle detection. Even if the vehicle recognizer 404 cannot recognize the vehicle, when the validity determiner 406 determines that the arrangement of the parts area has validity, and the intensity identifier 405 identifies that that the light intensity of both the reflected light image and the background light image for the vehicle area is low, it is preferable for the vehicle detector 407 to detect a vehicle. The above-described situation means that, even if the vehicle recognizer 404 is unable to recognize a vehicle due to a low reflection factor because a sufficient number of points cannot be obtained in a point group, when (a) the arrangement of the parts area has validity and (b) the light intensity of both the reflected light image and the background light image for the vehicle area is low, there is a particularly high possibility that a vehicle with a low reflection factor exists in the vehicle area.

The vehicle detector 407 may be configured to detect a vehicle when the validity determiner 406 determines that the parts area has validity. The above-described situation means that, if the arrangement of the parts area has validity, it raises a possibility that it is a vehicle.

The vehicle detector 407 may determine whether to detect a vehicle based on whether each of the conditions described above is satisfied. The vehicle detector 407 may determine whether each of the above-described conditions is satisfied based on a rule or based on machine learning.

The vehicle detector 407 outputs a final result of whether or not a vehicle is detected by the vehicle detector 407 to the automatic driving ECU 5. The vehicle detector 407 may also estimate the position and the posture of the vehicle from the result of the 3D detection process performed by the 3D detection processor 403, and may output the estimation to the automatic driving ECU 5. In addition, when the intensity identifier 405 identifies that the light intensity of both the reflected light image and the background light image for the vehicle area is low, the vehicle detector 407 may output, to the automatic driving ECU 5, an estimation result that the vehicle is black.

### Vehicle Detection Related Process in Processing unit 41

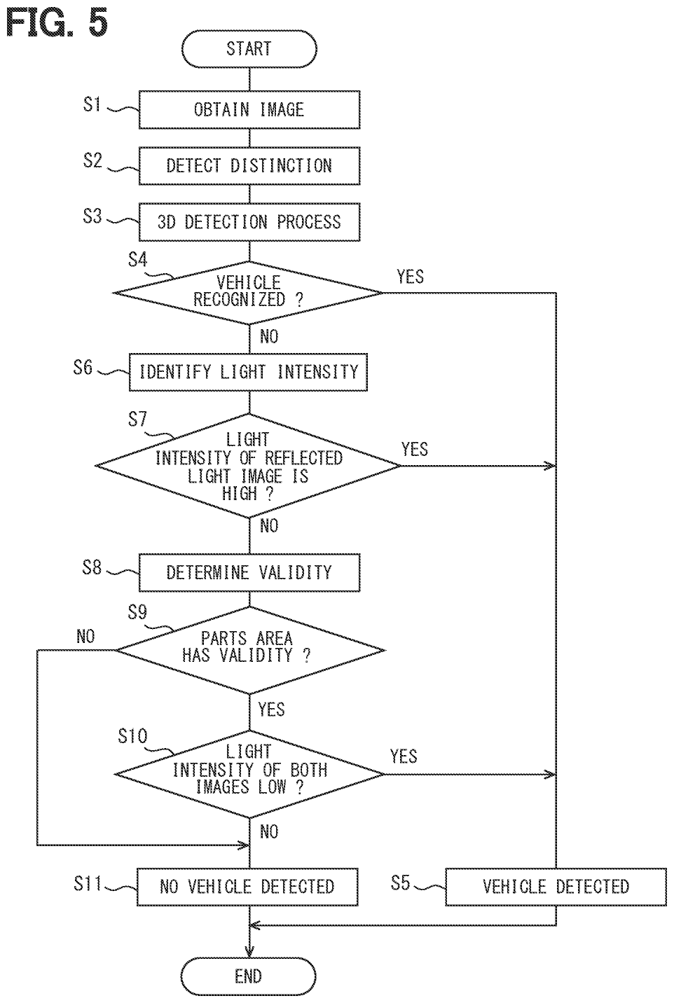

Here, an example of a process related to vehicle detection (hereinafter referred to as vehicle detection related process) performed by the processing unit 41 will be explained using a flowchart of FIG. 5. The flowchart of FIG. 5 is configured such that it is started every measurement period of the LiDAR device 3 when a switch (hereinafter referred to as a power switch) for starting the internal combustion engine or motor generator of the own vehicle is turned on, for example.

First, in step S1, the image obtainer 401 obtains a reflected light image and a background light image output from the LiDAR device 3. In step S2, the distinction detector 402 distinguishes and detects a vehicle area and a parts area from the background light image obtained in step S1. Further, the distinction detector 402 also distinguishes and detects the vehicle area and the parts area from the reflected light image obtained in step S1.

In step S3, the 3D detection processor 403 performs the 3D detection process on the reflected light image obtained in step S1. In step S4, the vehicle recognizer 404 recognizes the vehicle based on the result of the 3D detection process in step S3. If the vehicle recognizer 404 recognizes the vehicle (YES in step S4), the process shifts to step S5. On the other hand, if the vehicle recognizer 404 cannot recognize the vehicle (NO in step S4), the process shifts to step S6. In step S5, the vehicle detector 407 detects the vehicle and ends the vehicle detection related process.

In step S6, the intensity identifier 405 identifies the level of light intensity of the background light image and the reflected light image obtained in step S1 for the vehicle area detected in step S2. Here, an example configuration is explained in which when the vehicle recognizer 404 recognizes a vehicle, the intensity identifier 405 does not perform a process of its own. According to the above, when the vehicle recognizer 404 has recognized the vehicle, an unnecessary process in the intensity identifier 405 is omissible. It may also be possible to adopt a configuration in which the intensity identifier 405 performs the process of its own regardless of whether the vehicle recognizer 404 has recognized the vehicle.

In step S7, if it is determined in step S6 that the light intensity of the reflected light image is high (YES in step S7), the process shifts to step S5. On the other hand, if it is determined in step S6 that the light intensity of the reflected light image is low (NO in step S7), the process shifts to step S8.

In step S8, the validity determiner 406 determines validity of the arrangement of the parts area detected in step S2 from the intensity distribution in the reflected light image obtained in step S1. Here, an example configuration is explained in which when the vehicle recognizer 404 recognizes the vehicle, the validity determiner 406 does not perform the process. According to the above, when the vehicle is recognized by the vehicle recognizer 404, it becomes possible to omit an unnecessary process in the validity determiner 406. Note that it may also be possible to adopt a configuration in which the validity determiner 406 performs the process regardless of whether the vehicle recognizer 404 has recognized the vehicle.

In step S9, if it is determined in step S8 that the arrangement of the parts area has validity (YES in step S9), the process shifts to step S10. On the other hand, if it is determined in step S8 that the arrangement of the parts area does not have validity (NO in step S9), the process shifts to step S11.

In step S10, if it has been determined in step S6 that the light intensity of both the reflected light image and the background light image is low (YES in step S11), the process shifts to step S5. On the other hand, if it has been determined in step S6 that the light intensity of either the reflected light image or the background light image is high (NO in step S10), the process shifts to step S11. In step S11, the vehicle detector 407 does not detect a vehicle, and ends the vehicle detection related process.

Note that it may also be possible to adopt a configuration in which the process of S10 is omitted. In such case, if YES in step S9, the process may proceed to S4. Also, it may also be possible to adopt a configuration in which the process of S7 is omitted. In such case, the process may be configured to shift from S6 to S8. Although the flowchart in FIG. 5 shows an example in which the 3D detection processor 403 employs F-PointNet, the present disclosure is not necessarily limited thereto. For example, when PointPillars or the like is employed in the 3D detection processor 403, it is not necessary to perform the process in the distinction detector 402 before the 3D detection process. In such case, the process by the distinction detector 402 may be configured to be performed after the 3D detection process. In such manner, it possible to eliminate the waste of process in the distinction detector 402 before the 3D detection process. For example, it may also be possible to adopt a configuration in which the process by the distinction detector 402 (a) is performed when the vehicle recognizer 404 cannot recognize the vehicle, but (b) is not performed when the vehicle recognizer 404 can recognize the vehicle. Thereby, when the vehicle recognizer 404 has recognized the vehicle, it is possible to omit an unnecessary process in the distinction detector 402.

### Summary of Embodiment 1

Depending on whether or not a vehicle is located in the detection area, possible patterns of trends in the light intensity of the background light image and the reflected light image are narrowed down. Therefore, according to the configuration of Embodiment 1, by detecting a vehicle using the level of the light intensity of the background light image and the reflected light image of the detection area, it is possible to detect the vehicle with higher accuracy. In addition, since the parts area is an area that is assumed to be a specific vehicle part where the intensity of the reflected light tends to be high, it is estimated that the intensity of the reflected light tends to be high even if the vehicle body has a low reflectance. Therefore, it is highly possible that the intensity distribution in the reflected light image will also carry/inherit the intensity distribution according to the arrangement of that specific vehicle part. Therefore, according to the configuration of the Embodiment 1, by using the validity of the arrangement of the parts area from the intensity distribution in the reflected light image, it becomes possible to detect the vehicle with higher accuracy. As a result, even when an image representing the received intensity of the reflected light is used to detect a vehicle, it is possible to detect the vehicle with high accuracy.

According to the configuration of the Embodiment 1, since the SPAD is used as the light receiving element 321, it becomes possible to also obtain the background light image using the same light receiving element 321 that is used to obtain the reflected light image. Furthermore, according to the configuration of the Embodiment 1, since the reflected light image and the background light image are obtained by the common light receiving element 321, it is possible to eliminate the time synchronization and calibration effort between the reflected light image and the background light image.

### Embodiment 2

In the Embodiment 1, a configuration is shown in which the reflected light image and the background light image are obtained by the common light receiving element 321. However, the present disclosure is not necessarily limited thereto. For example, a configuration in which the reflected light image and the background light image are obtained by different light receiving elements (hereinafter referred to as Embodiment 2) may be adoptible. Hereinafter, the configuration of the Embodiment 2 is described.

### Schematic Configuration of Vehicle System 1a

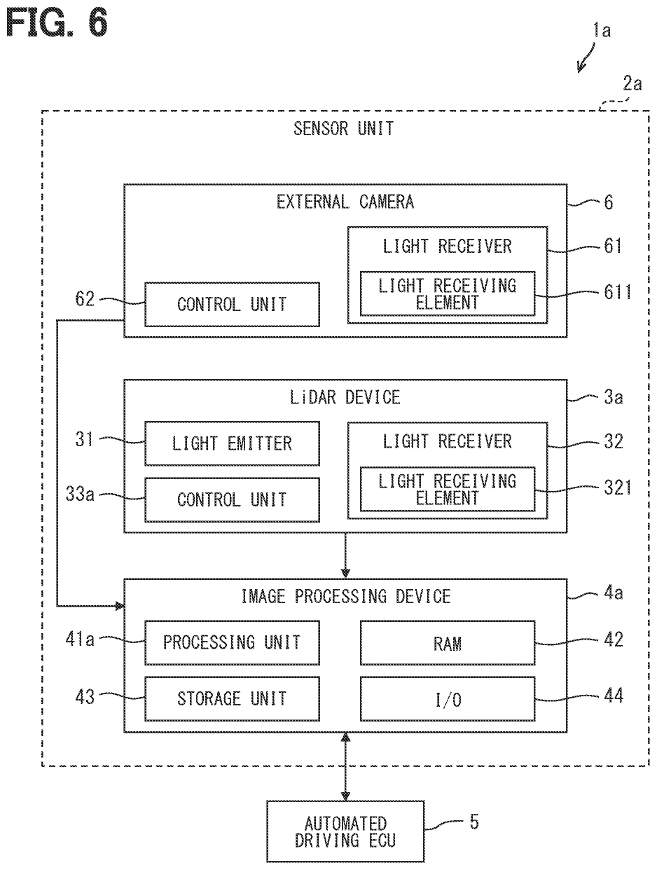

A vehicle system 1a can be used in a vehicle. The vehicle system 1a includes a sensor unit 2a and an automatic driving ECU 5, as shown in FIG. 6. The vehicle system 1a is the same as the vehicle system 1 of the Embodiment 1 except that it includes a sensor unit 2a instead of the sensor unit 2. The sensor unit 2a includes a LiDAR device 3a, an image processing device 4a, and an external camera 6, as shown in FIG. 6.

### Schematic Configuration of LiDAR Device 3a

As shown in FIG. 6, the LiDAR device 3a includes a light emitter 31, a light receiver 32, and a control unit 33a. The LiDAR device 3a is the same as the LiDAR device 3 of the Embodiment 1 except that it includes a control unit 33a instead of the control unit 33.

The control unit 33a is similar to the control unit 33 of the Embodiment 1 except that it does not have a background light measurement function. The light receiving element 321 of the LiDAR device 3a may or may not use the SPAD.

### Schematic Configuration of External Camera 6

The external camera 6 images a predetermined range of an external world of the own vehicle. The external camera 6 maybe positioned, for example, on an interior side of a front windshield of the own vehicle. It is assumed that an imaging range of the external camera 6 at least partially overlaps with a measurement range of the LiDAR device 3a.

The external camera 6 includes a light receiver 61 and a control unit 62, as shown in FIG. 6. The light receiver 61 collects incident light from the imaging range using, for example, a light receiving lens, and causes the light to enter a light receiving element 611. This incident light corresponds to the background light. The light receiving element 611 can also be referred to as a camera element. The light receiving element 611 is an element that converts light into an electrical signal by photoelectric conversion, and can be implemented as, for example, a CCD sensor or a CMOS sensor. The light receiving element 611 is set to have higher sensitivity in the visible region than in the near-infrared region in order to efficiently receive natural light in the visible region. The light receiving element 611 has a plurality of light receiving pixels arranged in an array in a two-dimensional direction. For example, red, green, and blue color filters may be arranged on the light receiving pixels adjacent to one another. Each light receiving pixel receives a visible light of one color corresponding to the arranged color filter. By measuring the intensity of red, green, and blue, the camera image taken by the external camera 6 becomes a color image in the visible range. Therefore, the external camera 6 can also be called as a color camera. The camera image obtained by the external camera 6 also corresponds to the background light image.

The control unit 62 is a unit that controls the light receiver 61. The control unit 62 maybe positioned on a common substrate with the light receiving element 611, for example. The control unit 62 is mainly composed of a broadly-defined processor such as a microcomputer or FPGA. The control unit 62 implements an imaging function.

The imaging function is a function for capturing a color image as described above. The control unit 62 reads a voltage value based on the incident light received by each light receiving pixel using, for example, a global shutter method at a timing based on the operating clock of a clock oscillator provided in the external camera 6, and detects and measures the intensity of the incident light. The control unit 62 can generate a camera image, which is image-like data in which the intensity of incident light is associated with two-dimensional coordinates on an image plane corresponding to the imaging range. These camera images are sequentially output to the image processing device 4a.

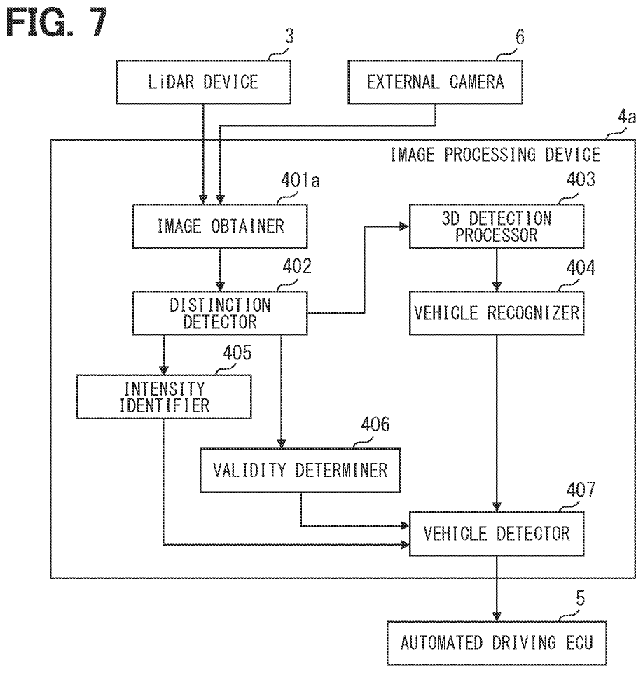

Next, a schematic configuration of the image processing device 4a will be described using FIG. 6 and FIG. 7. As shown in FIG. 6, the image processing device 4a is an electronic control device that includes an arithmetic circuit including a processing unit 41a, a RAM 42, a storage unit 43, and an I/O 44. The image processing device 4a is the same as the image process device 4 of the Embodiment 1 except that it includes a processing unit 41a instead of the processing unit 41.

As shown in FIG. 7, the image processing device 4a includes an image obtainer 401a, a distinction detector 402, a 3D detection processor 403, a vehicle recognizer 404, an intensity identifier 405, a validity determiner 406, and a vehicle detector 407 respectively provided as a functional block. This image processing device 4a also corresponds to a vehicle detection device. Further, the execution of the process of each functional block of the image processing device 4a by the computer also corresponds to performing the vehicle detection method. The functional blocks of the image processing device 4a are the same as those of the image process device 4 of the Embodiment 1, except that the image obtainer 401a is provided instead of the image obtainer 401.

The image obtainer 401a sequentially obtains reflected light images output from the LiDAR device 3a. The image obtainer 401a sequentially obtains camera images output from the external camera 6 as the background light images. The measurement range in which a reflected light image is obtained by the LiDAR device 3a and the imaging range in which a background light image is obtained by the external camera 6 partially overlap. This overlapping range is defined as a detection area. Therefore, the image obtainer 401a obtains (a) a reflected light image representing the intensity distribution of the reflected light obtained by detecting the reflected light of the light irradiated to the detection area with the light receiving element 321 having sensitivity in the non-visible region, and (b) a background light image representing the intensity distribution of the ambient light obtained by detecting the ambient light in the detection area that does not include the reflected light with the light receiving element 611 having sensitivity in the visible range, which is different from the light receiving element 321. The process in the image obtainer 401a described above also corresponds to an image obtainer process.

Note that, in the image processing device 4a, the reflected light image outputted from the LiDAR device 3a and the background light image outputted from the external camera 6 maybe time-synchronized using a time stamp or the like. Also, the image processing device 4a also performs calibration according to a deviation between a measurement base point of the LiDAR device 3a and an imaging base point of the external camera 6. In such manner, the coordinate system of the reflected light image and the coordinate system of the background light image are treated as the same coordinate system that coincides with each other.

### Summary of Embodiment 2

The configuration of the Embodiment 2 is similar to the configuration of the Embodiment 1, except for the configuration regarding whether the background light image is obtained by the LiDAR device 3 or the external camera 6. Therefore, similarly to the Embodiment 1, even when an image representing the received intensity of the reflected light is used for detecting a vehicle, it is possible to detect the vehicle with high accuracy.

Further, according to the configuration of the Embodiment 2, since color information is added to the background light image, it becomes easier to identify a black target object. Therefore, it becomes possible to further improve the accuracy of vehicle detection.

### Embodiment 3

In the embodiments described above, a configuration has been shown in which the vehicle area detected by the distinction detector 402 also includes a parts area, but the present disclosure is not necessarily limited thereto. For example, a configuration may be adopted in which the parts area is excluded from the vehicle area detected by the distinction detector 402. In such case, an area obtained by subtracting the parts area from the vehicle area of the Embodiment 1 maybe detected as the vehicle area.

### Embodiment 4

In the above-described embodiments, a case where the sensor units 2 and 2a are used in a vehicle has been described as an example, but the present disclosure is not necessarily limited thereto. For example, the sensor units 2 and 2a may be configured to be used in a movable object other than a vehicle. Examples of the movable object other than the vehicle include a drone and the like. Further, the sensor units 2 and 2a may be configured to be used for a stationary object other than a movable object. Examples of the stationary object include a roadside machine and the like.

Note that the present disclosure is not limited to the embodiments described above, and can variously be modified within the scope of the disclosure. An embodiment obtained by appropriately combining the technical features disclosed in different embodiments is also included in the technical scope of the present disclosure. Further, the control unit and the method thereof described in the present disclosure may be implemented by a dedicated computer which includes a processor programmed to perform one or more functions implemented by a computer program. Alternatively, the device and the method thereof described in the present disclosure may also be implemented by a dedicated hardware logic circuit. Alternatively, the device and the method thereof described in the present disclosure may also be implemented by one or more dedicated computers configured as a combination of a processor executing a computer program and one or more hardware logic circuits. The computer program may also be stored in a computer-readable, non-transitory tangible storage medium as instructions to be executed by a computer.

What is claimed is:

1. A vehicle detection device comprising:
an image obtainer configured to
detect, with a light receiving element, a reflected light of a light irradiated to a detection area to obtain a reflected light image representing an intensity distribution of the reflected light, and
detect, with the light receiving element, an ambient light, which does not include the reflected light, in the detection area to obtain a background light image representing an intensity distribution of an ambient light;
a distinction detector configured to distinguish and detect, from the background light image obtained by the image obtainer, a vehicle area, which is estimated as likely to be a vehicle, and a parts area, which is estimated as likely to be a specific vehicle part in which an intensity of the reflected light tends to be high;
an intensity identifier configured to identify a magnitude of a light intensity of each of the background light image and the reflected light image, which is obtained by the image obtainer, in the vehicle area, which is detected by the distinction detector;
a validity determiner configured to determine validity of arrangement of the parts area based on the intensity distribution of the reflected light image, which is obtained by the image obtainer, in the parts area, which is detected by the distinction detector; and
a vehicle detector configured to detect the vehicle by using
the magnitude of the light intensity of each of the background light image and the reflected light image, which is identified by the intensity identifier and
the validity of the arrangement of the parts area, which is determined by the validity determiner.

2. The vehicle detection device according to claim 1 further comprising:
a vehicle recognizer configured to recognize a vehicle based on a 3D detection process, wherein
the 3D detection process
indirectly uses at least one of the background light image or the reflected light image obtained by the image obtainer or
directly uses the reflected light image obtained by the image obtainer, and
the vehicle detector is configured to
detect the vehicle, when the vehicle recognizer is capable of recognizing the vehicle, and
detect the vehicle, even when the vehicle recognizer is incapable of recognizing the vehicle, by using
a level of the light intensity of the background light image and a level of the light intensity of the reflected light image identified by the intensity identifier and
the validity of the arrangement of the parts area determined by the validity determiner.

3. The vehicle detection device according to claim 1, wherein
the vehicle detector is configured to detect the vehicle when the intensity identifier identifies that the light intensity of the reflected light image is high.

4. The vehicle detection device according to claim 3, wherein
the vehicle detector is configured
not to detect the vehicle, when the intensity identifier identifies that only the light intensity of the reflected light image is low among the reflected light image and the background light image, and
to detect the vehicle when the intensity identifier identifies that the light intensity of both the reflected light image and the background light image is low.

5. The vehicle detection device according to claim 4, wherein
the vehicle detector is configured
not to detect the vehicle when the arrangement of the parts area has no validity,
not to detect the vehicle when the validity determiner determines that the arrangement of the parts area has validity and when the intensity identifier identifies that only the light intensity of the reflected light image is low among the reflected light image and the background light image, and
detect the vehicle when the validity determiner determines that the arrangement of the parts area has validity and when the intensity identifier identifies that the light intensity of both the reflected light image and the background light image is low.

6. The vehicle detection device according to claim 3, wherein
the vehicle detector s configured
not to detect the vehicle when the validity determiner determines that the parts area does not have validity, and
to detect the vehicle when the validity determiner determines that the arrangement of the parts area has validity.

7. The vehicle detection device according to claim 1, wherein
the validity determiner is configured
to determine that the arrangement of the parts area in the parts area detected by the distinction detector has validity,
when the intensity distribution in the reflected light image obtained by the image obtainer is similar to a typical intensity distribution predetermined for the intensity distribution of the reflected light image representing a part of the vehicle in the vehicle, and
when the intensity distribution in the reflected light image obtained by the image obtainer is consistent with a typical positional relationship predetermined as at least one of a positional relationship of a part of the vehicle or a positional relationship between parts of the vehicle, and
to determine that the arrangement of the parts area in the parts area detected by the distinction detector does not have validity when the intensity distribution in the reflected light image obtained by the image obtainer is not consistent with the typical intensity distribution.

8. The vehicle detection device according to claim 1, wherein
the image obtainer is configured to
detect, with the light receiving element having sensitivity in a non-visible region, the reflected light of the light irradiated to the detection area to obtain the reflected light image representing the intensity distribution of the reflected light, and
detect, with the light receiving element that is same as the light receiving element at a timing different from detection of the reflected light, the ambient light, which does not include the reflected light, in the detection area to obtain the background light image representing the intensity distribution of the ambient light.

9. The vehicle detection device according to claim 1, wherein
the image obtainer is configured to
detect, with the light receiving element having sensitivity in a non-visible region, the reflected light of the light irradiated to the detection area to obtain the reflected light image representing the intensity distribution of the reflected light, and
detect, with a different light receiving element having sensitivity in a visible range, the ambient light, which does not include the reflected light, in the detection area to obtain the background light image representing the intensity distribution of the ambient light.

10. A vehicle detection method implemented by at least one processor, the vehicle detection method comprising:
detecting, in an image obtainer process, with a light receiving element, a reflected light of a light irradiated to a detection area to obtain a reflected light image representing an intensity distribution of the reflected light;
detecting, in the image obtainer process, with the light receiving element, an ambient light, which does not include the reflected light, in the detection area to obtain a background light image representing an intensity distribution of an ambient light;
distinguishing and detecting, in a distinction detector process, from the background light image obtained in the image obtainer process, a vehicle area, which is estimated as likely to be a vehicle, and a parts area, which is estimated as likely to be a specific vehicle part in which an intensity of the reflected light tends to be high;
identifying, in an intensity identifier process, magnitude of a light intensity of each of the background light image and the reflected light image, which is obtained in the image obtainer process, in the vehicle area, which is detected in the distinction detector process;
determining, in a validity determiner process, validity of arrangement of the parts area based on the intensity distribution of the reflected light image, which is obtained in the image obtainer process, in the parts area, which is detected in the distinction detector process; and
detecting, in a vehicle detector process, the vehicle by using
the magnitude of the light intensity of each of the background light image and the reflected light image, which is identified in the intensity identifier process, and
the validity of the arrangement of the parts area, which is determined in the validity determiner process.

11. A non-transitory computer readable medium storing a vehicle detection program comprising instructions configured to be executed by at least one processor, the instructions configured to, when executed by the at least one processor, cause the at least one processor to:
detect, in an image obtainer process, with a light receiving element, a reflected light of a light irradiated to a detection area to obtain a reflected light image representing an intensity distribution of the reflected light;
detect, in the image obtainer process, with the light receiving element, an ambient light, which does not include the reflected light, in the detection area to obtain a background light image representing an intensity distribution of an ambient light;
distinguish and detect, in a distinction detector process, from the background light image obtained in the image obtainer process, a vehicle area, which is estimated as likely to be a vehicle, and a parts area, which is estimated as likely to be a specific vehicle part in which an intensity of the reflected light tends to be high;
identify, in an intensity identifier process, magnitude of a light intensity of each of the background light image and the reflected light image, which is obtained in the image obtainer process, in the vehicle area, which is detected in the distinction detector process;
determine, in a validity determiner process, validity of arrangement of the parts area based on the intensity distribution of the reflected light image, which is obtained in the image obtainer process, in the parts area, which is detected in the distinction detector process; and
detect, in a vehicle detector process, the vehicle by using
the magnitude of the light intensity of each of the background light image and the reflected light image, which is identified in the intensity identifier process, and
the validity of the arrangement of the parts area, which is determined in the validity determiner process.

12. A vehicle detection device comprising:
at least one processor; and
at least one memory storing instructions configured to, when executed by the processor, cause the at least one processor to:
detect, in an image obtainer process, with a light receiving element, a reflected light of a light irradiated to a detection area to obtain a reflected light image representing an intensity distribution of the reflected light;
detect, in the image obtainer process, with the light receiving element, an ambient light, which does not include the reflected light, in the detection area to obtain a background light image representing an intensity distribution of an ambient light;
distinguish and detect, in a distinction detector process, from the background light image obtained in the image obtainer process, a vehicle area, which is estimated as likely to be a vehicle, and a parts area, which is estimated as likely to be a specific vehicle part in which an intensity of the reflected light tends to be high;
identify, in an intensity identifier process, magnitude of a light intensity of each of the background light image and the reflected light image, which is obtained in the image obtainer process, in the vehicle area, which is detected in the distinction detector process;
determine, in a validity determiner process, validity of arrangement of the parts area based on the intensity distribution of the reflected light image, which is obtained in the image obtainer process, in the parts area, which is detected in the distinction detector process; and
detect, in a vehicle detector process, the vehicle by using
the magnitude of the light intensity of each of the background light image and the reflected light image, which is identified in the intensity identifier process, and
the validity of the arrangement of the parts area, which is determined in the validity determiner process.
